(19) United States
(12) Patent Application Publication
(10) Pub. No.: US 2020/0004877 A1
(43) Pub. Date: Jan. 2, 2020

(54) METHODS AND SYSTEMS FOR INTELLIGENT AUTOMATED TASK ASSESSMENT AND LIST GENERATION

(71) Applicant: Entefy Inc., Palo Alto, CA (US)

(72) Inventors: Alston Ghafourifar, Los Altos Hills, CA (US); Mehdi Ghafourifar, Los Altos Hill, CA (US); Brienne Ghafourifar, Los Altos Hills, CA (US)

(21) Appl. No.: 16/020,062

(22) Filed: Jun. 27, 2018

(51) Int. Cl. G06F 17/30

(52) U.S. Cl. CPC G06F 17/30705; H04L 67/10

(57) ABSTRACT

Improved message presentation and interaction of users, with respect to the receipt of and response to multi-protocol message events, includes generating summarizations of messages, valuation assessments of messages, and/or prioritization information. Summarization, value assessment generation, and prioritization may utilize a context of the message, its content, historical messages, time-based attributes, and/or other real-life conditions. Assessing relative values of messages is accomplished according to a valuation metric and complexity determination. A different valuation metric may be provided for each user. User information for a “new” message may be presented after: context-aware processing of the new message; context aware processing of attributes of the user that receives the message; and/or historical information based on previously received similar messages. Processing may be performed both at the time the message is available (i.e., sent/received) and/or in near real-time, i.e., as a user is about to see information about the message for the first time.

### CROSS REFERENCE TO RELATED APPLICATIONS

This application is related to U.S. Non-Provisional patent application Ser. No. 15/859,140, entitled “Methods and Systems to Support Smart Message and Thread Notification and Summarization,” by Alston Ghafourifar et al., filed on Dec. 29, 2017, which is incorporated by reference herein in its entirety for all applicable purposes.

### TECHNICAL FIELD

This disclosure relates generally to apparatuses, methods, and computer readable media for improved interaction of users with respect to the receipt of and response to multi-protocol message events. More particularly, this disclosure relates to providing a communication system to analyze user message activity to provide context-aware summarization and automatic task list generation with response prioritization for outstanding or new message events.

### BACKGROUND

Modern consumer electronics are capable of enabling the transmission of messages using a variety of different communication protocols. More specifically, text messages (such as SMS/MMS, Instant Messages (IMs), etc.) and emails represent the vast majority of direct communications between users. Each of these mechanisms support electronic exchange of information between users or groups of users. In some cases, information is simply “posted” and may not be directly related to any particular message thread. In other cases, information may be directed to a user such that a “reply” or further communication or action (e.g., a task completion) is expected. In short, today's technologies provide multi-protocol input of information to users and it is largely up to the recipient to determine what to do with the information (e.g., comment, reply, ignore, pass on to another party) and when to take any such action on the information.

One problem associated with existing (and possibly future) methods of exchanging messages between parties is that messages are received in a largely stand-alone fashion. Using today's available communication techniques, each individual message lacks a contextual relationship with other messages and may not take into account a context of the user receiving the message at the time the message is delivered to that user. At best, email messages may represent a thread of related communications that are only connected to each other because of a common subject line. Further, often in a long thread of email messages (e.g., many distinct messages), the subject line becomes less relevant as the topics in the body of the email evolve. However, the subject line is “intentionally” not changed by the users because, even though it may not be currently accurate, it is a typical way for users to tie back to the original email. Thus, users often keep an original subject line on an email exchange well after it has lost any significance about the current state of the activity being discussed in each email body.

Another problem, referenced briefly above, is that the context of the receiving user of a message is not taken into account by today's techniques. The context of both users and messages change over time as a result of multiple factors and variables. For example, in the interim between a message being sent and a user being aware of the message for the first time, the state of an activity mentioned in the message may have changed. In a real world example, a user may be sent a text message to get something at a grocery store by their spouse. If that person is not actively monitoring their messages (e.g., on the golf course, in the shower, on an airplane, etc.) then, when they actually view that message (e.g., become aware of the message), its information may be “out of date.” For example, the spouse may have already gone to the store and obtained the item, or may have sent a subsequent email (i.e., another message in a different protocol) that overrides the initial request.

In a simpler example, a user may have received a text message about a subject and in the interim time-period, e.g., during which the user is not monitoring text messages, may have received several emails on the same subject. If that user, upon returning to actively use the device, responds to the text message, the information provided likely will not take into account anything from the emails. However, if the user were aware of the existence of the emails and their content, the text message response may be altered significantly (or not sent at all) because the reply to outdated information may simply cause confusion (or worse). To address this situation of receiving a plurality of messages in an interim where a user is not using their device, the disclosed system represents an improvement over existing messaging technologies, in part, because disclosed implementations may: a) receive an indication that the user has returned to the device (e.g., device pickup); b) determine if the text message has been associated with any unprocessed contexts (e.g., interim messages); c) generate an augmented summary taking into account all available information; and d) generate a prioritized task list to optimize efficiency of addressing outstanding task items for a particular user. The prioritization being maintained, in part, using a history and knowledge base of previously received messages, completed tasks, and assessment of value associated with a response. In this manner, a user may be informed with an intelligently generated summary of the related information rather than that user reacting to only the text message. Further, a user may be provided a user interface “instructing” them as to what to do next to perform tasks in a manner that may be optimal to the organization—rather than optimal based on their own present knowledge of the situation. Dynamically maintaining a “to-do” list that is aware of activities of other people, e.g., people within an organization, and their task progress represents an improvement to the art of resource planning and task scheduling.

### BRIEF DESCRIPTION OF THE DRAWINGS

Embodiments described herein are illustrated by examples and not limitations in the accompanying drawings, in which like references indicate similar features. Furthermore, in the drawings some conventional details have been omitted so as not to obscure the inventive concepts described herein.

FIG. 1 illustrates, in block diagram form, an example architecture 100 that includes electronic components for servicing message transmission and analysis in accordance one or more embodiments.

FIG. 2 illustrates an example communications server infrastructure 200 configured to analyze and correlate messages to provide improved user interaction, according to one or more embodiments disclosed herein. The infrastructure 200 may be used to support an Automatic Task List Generation Based on Priority and Efficiency Assessments system as described herein.

FIGS. 3A-C illustrate different stages of a two-dimensional (“2D”) graphical approximation of a multi-dimensional context management graph (“context graph”) 300 as it may change over time in accordance with one or more embodiments.

FIG. 4A illustrates a message timeline 400 representing six messages from three different sending entities and two read events for use in explaining how messages may be automatically summarized and prioritized including possible, auto-response options, value assessments, and task prioritization; while taking into account a plurality of contexts for a user, according to one or more disclosed embodiments.

FIG. 4B-C illustrate block diagrams 450 and 480 to provide an example for a set of messages and corresponding automatically generated: summarization, value assessment, prioritization, completion time, and possible task list generation, along with a possible prioritized task list message interface, according to one or more disclosed embodiments.

FIG. 5 illustrates one example message management technique 500 in accordance with one or more embodiments.

FIG. 6 illustrates, in flowchart form, a process 600 to analyze a message to provide an automatically generated summary and possible auto-response options including possible value assessment, prioritization and task list generation based, in part, on a user's context and a messages relationship to historical message thread information (and other information including previously determined task completion metrics) in accordance with at least one embodiment.

FIG. 7A is a block diagram illustrating a computing device 700, which could be used to execute the various processes described herein, according to one or more disclosed embodiments.

FIG. 7B is a block diagram illustrating a processor core, which may reside on processing device 700, according to one or more disclosed embodiments.

### DETAILED DESCRIPTION

Disclosed are apparatuses, methods, and computer readable media for improved message presentation to a user. More particularly, but not by way of limitation, improved interaction of users, with receipt and response to multi-protocol message events, includes providing an automatically generated summarization of messages including indications of the relative priority that should be afforded any particular message, as well as estimates of the user time required to process messages, e.g., task completion time estimates. The automatic generation of summarization, priority assessments, and time estimates may together and/or individually utilize a context of the message, its content, historical messages, time-based attributes, and other real-life conditions (e.g., geolocation, currently driving, asleep). That is, generation of summarization, priority assessments, and time estimates may take into account different context attributes and variables than the attributes used for response option generation. Processing may be performed both at the time the message is available (i.e., sent/received) and in near real-time as a user is about to see information about the message for the first time. Processing in near-real time may take into account current life conditions (or other contextual information) of the user or provide for information (e.g., subsequent messages) that has become available in the time between the message being available and the time of presentation.

Further, in some embodiments, a “value assessment” may be derived, assigned, and maintained for any message associated with a task. The value assessment may be determined uniquely for a given user, or may reflect a value to an organization (rather than to a particular individual). In some cases, a user may be directed to perform a task that is lower priority to themselves personally, but would have a greater benefit for the organization as a whole. For example, a supervisor providing an authorization to proceed. The supervisor may not believe the authorization to proceed is a high priority (e.g., value) task, however, the system may understand that several other resources may be utilized (at this point in time or in the future) more efficiently if that authorization is in place. To provide a specific detail for this example, the order clerk may have vacation scheduled next week so by not providing authorization today, the order required (and dependent on the authorization) may be delayed until the clerk returns from vacation. Thus an unexpected delay in the overall project may be averted if the supervisor alters his current priority. This is just one example of how automatic task prioritization may improve overall throughput of an organization. Many other examples will be apparent to one of ordinary skill in the art, given the benefit of this disclosure.

As used herein, an “entity” refers to a person (e.g., a user, another user, etc.), an organization (e.g., a corporation, a non-profit company, etc.), a service (e.g., a ride sharing service, social media), or any other entity responsible for initiating a message directed to a user.

As mentioned briefly above in the Background section, there are several problems with existing technologies used to provide electronic messages to users. In addition to the problems listed above, another problem associated with today's messaging techniques is that they do not provide a meaningful summary, such that a user may “at a glance” determine what a message is about or what messages (e.g., threads, group messages, messages and threads across groups of users, clusters of messages within a given group or thread) may have the most productive use of a user's limited time to respond. In most cases today, no indication of response value is provided at all, and, if a summary is provided, the summary consists of the first few lines of the underlying message. No meaningful extraction or augmentation of information, e.g., which may be used to convey important information via the “at a glance” summary, is performed by or for existing technologies.

Another problem associated with today's messaging techniques is their relative inability to provide relevant predictive and reactive solutions to a user's messages based on the user's context. Generally, the user's context is completely ignored when messages are delivered. If a user's context is taken into account at all, then the context derivation may not take into account message content. For example, when a user is driving and they receive messages on their smartphone, an auto-response may be generated to let the sender (or caller) know that the person is currently driving and will respond later. However, this is a pre-defined auto response that would send the same message without regard to information within the incoming message, or would pull from a finite set of pre-defined messages, one of which may be selected based on a shallow analysis of the message. In another example, a user may be in a meeting and be presented a generic auto-response option like (“Sorry can't talk right now”). However, if the text message was determined to come from someone related to the subject matter of the meeting (e.g., on the invite list, on emails about the meeting subject, had previously sent an email requesting something from that meeting, etc.) then, using the techniques of this disclosure, the auto-response option may be generated and be more meaningful. For example, “Where are you? You are supposed to be in this meeting.” or possibly, “I am currently in a meeting discussing” (subject discussed in email inserted here) “and will call you in about” (time estimate presented here based on meeting schedule in user's calendar). Clearly, the pre-defined responses may be replaced with improved “context aware” auto-responses that are generated using the techniques of this disclosure.

Another problem associated with current messaging and message processing techniques is that they do not provide a gauge or assessment of any given message's relative priority to message recipients. For example, a recipient may receive multiple messages varying in terms of their content, their attachments, and other factors, affecting the likely extents of time and effort necessary for the recipient to respond to or otherwise act upon any given message. Generally, no indication is provided to a user of the relative value of processing one out of a plurality of messages over the value of processing others. Further, no indication of the amount of time to “react, perform, and respond” to a message (e.g., perform underlying actions implied by the content of the messages) is provided by current technologies.

The subject matter of the present disclosure is directed to overcoming, or at least reducing the effects of, one or more of the problems set forth above. To address these and other issues, techniques that process a message based on the context of that message and possibly the current real-life context of the user are described herein. Disclosed techniques also allow for automatic generation of a summary that may contain more “meaningful” information to a user as opposed to simply the first portion of the message. Additionally, disclosed techniques allow for automatic generation of response options that may take into account “current” real-life attributes of the user about to initially be made aware of the message.

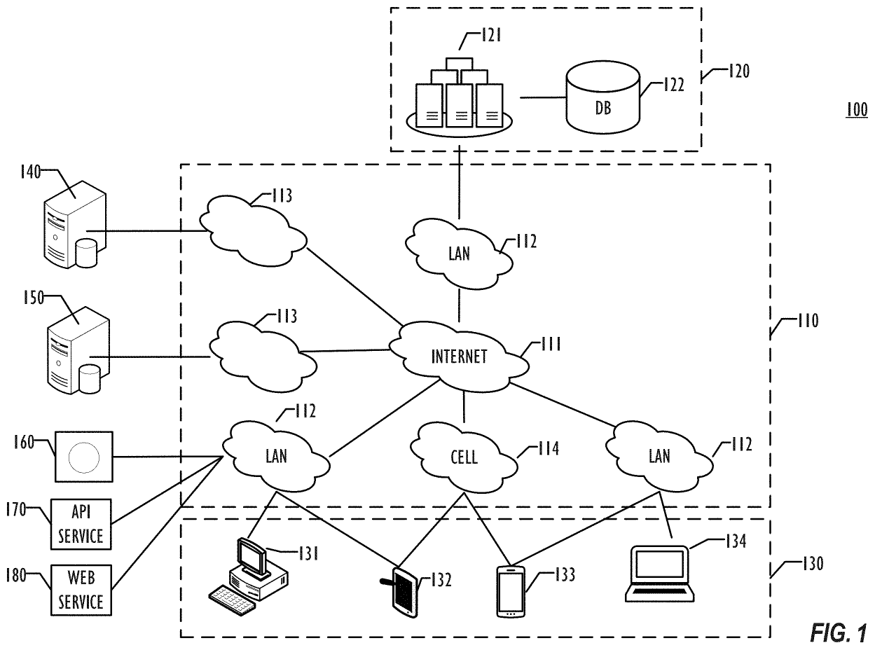

Referring now to FIG. 1, a network architecture infrastructure 100 is shown schematically. Infrastructure 100 includes computer networks 110, interaction platform devices included in a messaging infrastructure 120 (e.g., devices implementing a context-aware smart message and thread notification, summarization, prioritization and time estimation infrastructure according to one or more disclosed embodiments), client devices 130, third-party communications devices 140, third-party service provider devices 150, smart devices 160, third-party ‘API-enabled’ services 170, and third-party ‘Web-enabled’ services 180. Note that devices may be either physical or virtualized and may run on dedicated hardware or exist dynamically in the cloud.

The computer networks 110 may include any communications network that allows computers to exchange data, such as the internet 111, local area networks 112, corporate networks 113, cellular communications networks 114, etc. Each of the computer networks 110 may operate using any number of network protocols (e.g., TCP/IP). The computer networks 110 may be connected to each other and to the various computing devices described herein (e.g., the messaging infrastructure 120, the client devices 130, the third-party communications devices 140, the third-party service provider devices 150, the smart devices 160, the third-party ‘API-enabled’ services 170, and the third-party ‘Web-enabled’ services 180) via hardware elements such as gateways and routers (not shown).

Messaging infrastructure 120 may include one or more servers 121 and one or more storage devices 122. The one or more servers 121 may include any suitable computer hardware and software configured to provide the features disclosed herein. Storage devices 122 may include any tangible computer-readable storage media including, for example, read-only memory (ROM), random-access memory (RAM), magnetic disc storage media, optical storage media, solid state (e.g., flash) memory, etc.

Client devices 130 may include any number of computing devices that enable an end user to access the features disclosed herein. For example, client devices 130 may include, for example, desktop computers 131, tablet computers 132, mobile phone 133, notebook computers 134, etc.

Third-party communications devices 140 may include email servers such as a GOOGLE® Email server (GOOGLE is a registered service mark of Google Inc.), third-party instant message servers such as an Instant Messaging (IM) server, third-party social network servers such as a FACEBOOK® or TWITTER® server, cellular service provider servers that enable the sending and receiving of messages such as email messages, short message service (SMS) text messages, multimedia message service (MMS) messages, or any other device that enables individuals to communicate using any protocol and/or format.

Third-party service devices 150 may include any number of computing devices that enable an end user to request one or more services via network communication. For example, cloud-based software as a service (SAAS) or platform as a service (PAAS) providers and the applications they make available via the cloud. Smart devices 160 may include any number of hardware devices that communicate via any of the computer networks 110 and are capable of being controlled via network communication. Third-party ‘API-enabled’ services 170 may include any number of services that communicate via any of the computer networks 110 and are capable of being controlled via an Application Programming Interface (API), such as a ride-sharing service. Third-party ‘Web-enabled’ services 180 may include any number of services that may have no direct third-party interface, other than informational content, e.g., information hosted on a third-party website or the like, such as a train schedule, or a news feed.

The disclosed context-aware messaging infrastructure 120, therefore, can represent improvements to computer functionality. For example, the advantages of a messaging infrastructure described herein can assist with enabling users to better relate incoming messages to both real world events and information from other messages to present information in a more informative context to the user. A messaging system as described herein can further assist in enabling users to more efficiently prioritize their handling of messages; such ability is enhanced through provision of time estimates associated with messages. Such estimates may include the time required to process the message itself (including attachments), as well as the time required to perform any tasks implicated by the content of the message. This more informative context association may result in a reduction in the number of follow up messages needed and/or make overall communication more efficient. That is, a smart message and thread notification, summarization, prioritization, and time estimation system can assist with reducing inefficiency and wasted computational resources (e.g., computational resources that would otherwise not be necessary due to inefficient communications, etc.). The disclosed messaging infrastructure 120 may also integrate information from one or more of the many different types of messaging protocols and reduce time and confusion of users when dealing with multiple communication threads simultaneously. As described in further detail below, at least one embodiment of a smart message and thread notification and summarization system can be implemented using software, hardware, or a combination thereof.

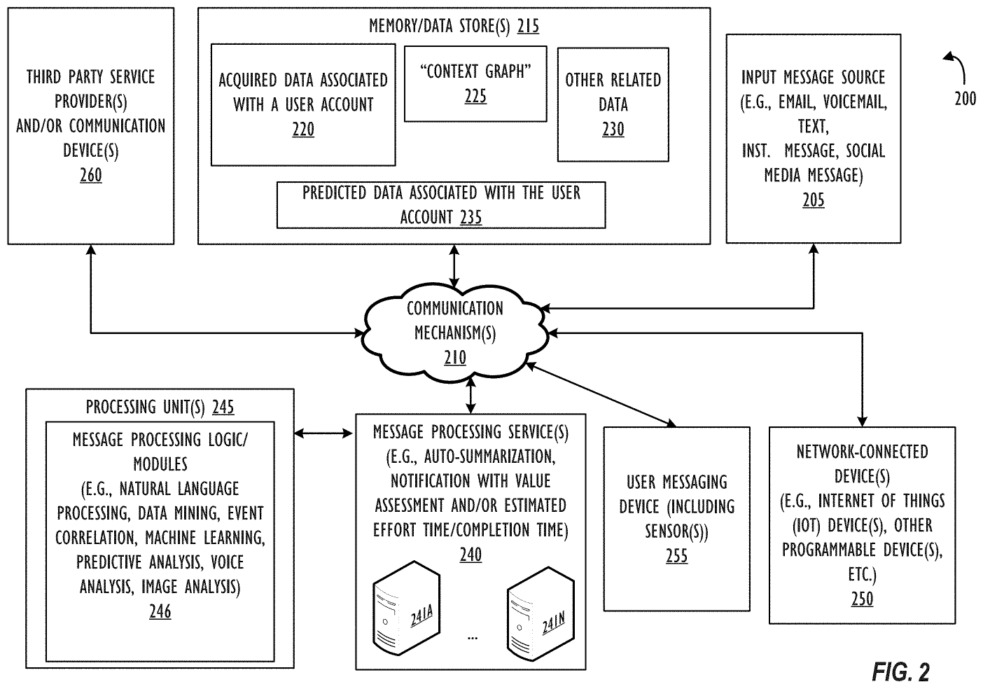

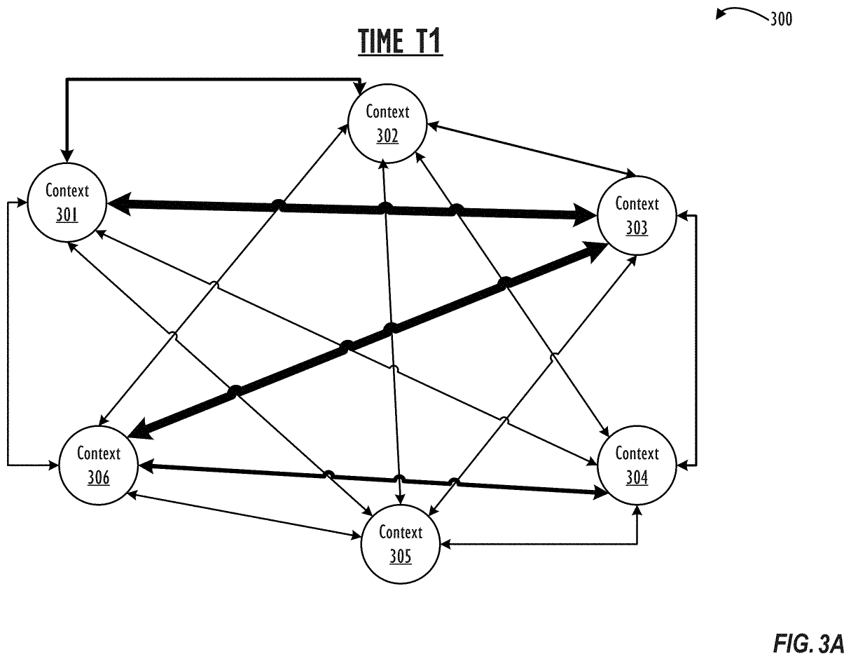

Referring now to FIG. 2 which illustrates, in block diagram form, an example communications server infrastructure 200 configured to analyze and correlate messages to provide improved user interaction, according to one or more embodiments disclosed herein. The infrastructure 200 may be used to support a smart message and thread notification, summarization, prioritization, and task list generation system as described herein. For one embodiment, the architecture 200 may include processing unit(s) 245, memory or data store(s) 215, third (3rd) party service provider(s) and/or communication device(s) 260, user messaging devices 255 (possibly including sensor(s) such as GPS or accelerometers), input messages sources 205, communication mechanisms 210, message processing service 240, and network-connected device(s) 250. For one embodiment, one or more components in the architecture 200 may be implemented as one or more integrated circuits (ICs). For example, at least one of processing unit(s) 245, communication mechanism(s) 210, 3rd party service(s)/device(s) 260, user messaging devices 255, network-connected device(s) 250, or memory 215 can be implemented as a system-on-a-chip (SoC) IC, a three-dimensional (3D) IC, any other known IC, or any known IC combination. For another embodiment, two or more components in architecture 200 are implemented together as one or more ICs. Each component of architecture 200 is described below. Message processing service 240 includes one or more computer devices 241A through 241N configured to perform the functions described herein for maintaining contexts, processing messages, creating automated augmented summarization of messages, prioritizing messages, estimating response times including implied actions, and generating auto-response “quick actions” that are based on the content and context of received messages.

Processing unit(s) 245 can include, but are not limited to, central processing units (CPUs), graphical processing units (GPUs), other integrated circuits (ICs), memory, and/or other electronic circuitry. For one embodiment, processing unit(s) 245 manipulates and/or processes data (e.g., data associated with user accounts, data associated with messages, data comprising contexts and events, data associated with processing operations/algorithms/techniques, etc.). Processing unit(s) 245 may include message processing modules/logic 246 for servicing messages and user interaction with respect to messages in accordance with one or more embodiments. For one embodiment, message processing modules/logic 246 is implemented as hardware (e.g., electronic circuitry associated with processing unit(s) 245, circuitry, dedicated logic, etc.), software (e.g., one or more instructions associated with a computer program executed by Processing unit(s) 245, software run on a general-purpose computer system or a dedicated machine, etc.), or a combination thereof.

Message processing modules/logic 246 can be employed in cooperation with one or more message processing service(s) 240 and a context graph 225 to perform tasks on behalf of users. Message processing modules/logic 246 may be part of a computing system (e.g., a laptop, server, a virtual machine, a programmable device, any other type of computing system, etc.) capable of processing user messages. User messages can be provided to architecture 200 in the form of user inputs messages from an input messages source 250. Messages may be received from a user messaging device 255 over a network via communications mechanisms 210. Further, data from third party service providers 260, network connected devices 250, and sensors from different devices may also be made available via communication mechanisms 210. Information from this additional data may be used to form or add to the context information as maintained in context graph 225 to assist with implementation of embodiments as disclosed herein.

Message processing service 240 can obtain or receive any type of data associated with servicing user messages received in a plurality of message protocols. This data includes digitalized data representing one or more activities associated with a user account. The data can, for example, also include data stored in memory/data store(s) 215. For one embodiment, and as shown in FIG. 2, this data can include acquired data 220 and/or predicted data 235. As used herein, “acquired data” refers to historical and current data about subjects identified in one or more messages for a given user account. The data can optionally also include predicted data 235, which refers to data resulting from processing acquired data. For yet another embodiment, the data includes information from one or more of provider(s)/device(s) 260, network-connected device(s) 250, and sensor(s) in a user messaging device 255.

One difference between acquired data 220 and predicted data 235 is that the acquired data 220 represents “hard data.” That is, the data 220 is known with a high degree of certainty, such as records of past activities or a record of current activity. Acquired data 220 can refer to any or all attributes of activities (and messages) associated with a user account. Example data 220 includes, but is not limited to, the following: image data from posted or sent images, data culled from message subjects, bodies, and attachments, news feed information, voice messages processed to determine content, previous task completion times, etc. For some embodiments, the acquired data 220 can be obtained from 3rd party service provider(s) 260, a social networking service, a weather reporting service, a calendar service, an address book service, any other type of service, or from any type of data store accessible via a wired or wireless network (e.g., the Internet, a private intranet, etc.). Further, data formats may be diverse and include, text, extensible markup language (XML), hypertext markup language (HTML), database formats, images, videos, etc. Each of these format types may be utilized to assist in the disclosed techniques for automatic summary generation and automatic task list generation, depending on the specific requirements of a given implementation.

On the other hand, predicted data 235 may be considered “soft data.” That is, predicted data 235 includes data about future activities associated a user or data mined and processed with machine learning techniques or otherwise derived or assessed via the data (e.g., non-linear intuitive data). One example of non-linear intuitive data may be a computer discovering a cat in a picture based on image processing/recognition techniques while metadata of the same picture may be considered hard data (e.g., file size, date/time of picture). For one embodiment, predicted data 235 represents the result of performing at least one of the following: (i) data mining acquired data 220; (ii) analyzing acquired data 220; (iii) applying logical rules to the acquired data 220; or (iv) any other known methods used to infer new information from provided or acquired information. For example, acquired data 220 may include a user's interactions with another user, while predicted data 235 may include predictions about how a user might respond to a received message. For this example, the data about the user's interactions with another user may be combined with other acquired data 220 (e.g., message from a third user, etc.) and processed to make the prediction.

Referring again to FIG. 2, message processing service 240 uses acquired data 220 and/or predicted data 235 to generate and maintain context graph 225. As shown in FIG. 1, all or some of context graph 225 can be stored processing unit(s) 245, memory 215, and/or the service(s) 240. As used herein, a “multi-dimensional context graph,” a “context graph” and their variations refer to a multi-dimensional, dynamically organized collection of data used by message processing service 240 for deductive reasoning. Further detail concerning a context graph methodology and implementation appropriate for the purposes of the present disclosure are provided in the above-referenced U.S. Non-provisional patent application Ser. No. 15/859,158, entitled “Methods and Systems to Support Adaptive Multi-Participant Thread Monitoring,” by Alston Ghafourifar, filed Dec. 29, 2017, which is hereby incorporated by reference herein in its entirety.

For one embodiment, a context graph such as context graph 225 acts as a knowledge based computer learning system that includes a knowledge base and/or an inference engine for a neural network. Consequently, context graph 225 represents a dynamic resource that has the capacity to “learn” as new information (e.g., data 220, data 235, etc.) is added. Context graph 225, as a knowledge based system of a neural network, enables more than accessing information and extrapolating data for inferring or determining additional data—it can also be used for classification (e.g., pattern and sequence recognition, novelty detection, sequential decision making, etc.); and data processing (e.g., filtering, clustering, blind source separation and compression, etc.). As used herein, a “dimension” refers to an aspect upon which contexts may be related, classified, or organized. A dimension can be based on time, location, subject, event, or entity.

Context graph 225 may include multiple nodes and edges. Each node can represent one or more units of data (e.g., the acquired data 220, the predicted data 235, a combination thereof, a context, a message, an event, etc.). Each edge (which may or may not be weighted) can represent relationships or correlations between the nodes.

For one embodiment, each node represents a context. As used herein, the term “context” and its variations refer to a category of one or more messages or events. Events are described below. Conceptually, a context can be thought of as a container that holds one or more items such that each container includes only similar or related events. Contexts can have varying levels of granularity. Contexts may be differentiated based on their varying levels of granularity.

For one embodiment, there are at least two distinct types of contexts that can be identified based on granularity levels—(i) a macro context; and (ii) a micro context. For example, macro contexts include broadly defined categories (e.g., meetings scheduled for a user, messages from a client, messages grouped at a corporate level, etc.), while micro contexts include more narrowly defined categories (e.g., messages referencing a specific task number, messages from a direct supervisor, etc.). Consequently, a macro context can include one or more micro contexts. For example, a macro context, which represents all of user A's messages with colleagues in California, USA can include micro context that represents all of user A's messages with colleagues in Palo Alto, Calif., USA. Context may also be differentiated based on their temporal properties.

For another embodiment, there are at least three distinct types of contexts that can be identified based on granularity levels and correspondence between contexts—(i) a macro context; (ii) a transactional context and (ii) a micro context. In this embodiment, the macro context and micro context are similar to those described above and a transactional context has been introduced. The transactional context may be used to relate events to each other so that events themselves can be used to derive correlations and relationships. These correlations and relationships may be used by the disclosed system to understand and discover patterns or other insights around activities associated with particular users. In short, understanding a transactional relationship between contexts may assist in further refining the techniques described throughout this disclosure.

For one embodiment, there are at least two distinct types of contexts that can be identified based on temporal properties—(i) a current context (also referred to herein as “an open context”); and (ii) a previous context (also referred to herein as “a closed context”). Open contexts are ongoing contexts that have not been resolved or closed because one or more future events can be included as part of the category. An open context can, for example, include messages relating to an ongoing task that User A is still working on and may have information about events that User A will perform at some future date, etc. Closed contexts are contexts that have been resolved. Examples of a closed context include context that is closed based on an activity (or stage of activity) being completed, a particular communication (e.g., text, phone call, email, etc.) that was received some time period in the past (tunable) for which there is no predicted or outstanding future activity. Furthermore, two or more contexts may include the same message or event—this is because a single message or event can be categorized under multiple categories.

In addition, contexts can be contingent upon one another. Consequently, and for one embodiment, each node in context graph 225 represents a category of one or more messages associated with a user account serviced by a message processing service. These categories may be used organize the data 220, 230, and/or 235 into manageable sets. Contexts can be perpetually created on an ongoing basis. For one embodiment, contexts may never be deleted. Instead, and for this embodiment, contexts may be maintained as nodes in context graph 225 and can be retrieved by the message processing service 240 on an as-needed basis.

Although one or more of the embodiments discussed in detail here may make use of a historical context graph and information outside of a particular message, it is possible that, in some cases, only data contained within a single message may be processed and used to create a meaningful summarization, auto-generated response options, and an assessment of the relative priority of a message in terms of such factors as the time- and cost-effectiveness of a user's attention to a message. Accordingly, the disclosed methods and systems may produce a meaningful response and valuation assessment from a single message. This may be thought of as creating a context for the message from the message itself—i.e., without requiring any additional data to augment the processing (i.e., a “self-contained context”). Additionally, the processing applied to a single message that cannot be associated with any previously defined context may be thought of as an initial condition, where a new context may be created for the first time and associated with this initial message.

As used herein, the term “event,” “real-life event,” “user life event,” and their variations refer to any data and/or changes in data associated with a user. Example events include, but are not limited to, one or more activities performed by the user, one or more activities associated with a relationship between the user and one or more entities, and one or more changes in status of a relationship between the user and one or more entities. Conceptually, events may take the form, for example, of a user attending a meeting, a particular communication (e.g., text, phone call, email, etc.) associated with a user, an appointment associated with a user, a location associated a user, a preference associated with a user, a work relationship between the user and another person, etc. Events can be determined by analyzing data associated with a user account (e.g., data 220, 230, or 235, etc.). Furthermore, relationships between data 220 itself, data 230 itself, and data 235 itself, and a combination of these data can be determined by analysis and/or processing techniques (e.g., data mining techniques, data analysis and analytics techniques, etc.). Messages/events and the relationships between the messages/events can be perpetually created on an ongoing basis. In some scenarios, each message/event can comprise one or more messages/events.

For one embodiment of context graph 225, edges between nodes represent relationships or correlations between the nodes. More specifically, a relationship or correlation between two contexts (which are represented as nodes) could be data (e.g., acquired data 220, predicted data 235, other data 230, an event, etc.) that is common to both contexts. For one embodiment, message processing service 240 uses the “hard data” to generate correlations or relationships between nodes (e.g., by generating a new edge between a pair of contexts represented as nodes in context graph 225, etc.). For a further embodiment, message processing service 240 uses the “soft data” to augment the generated correlations or relationships between nodes (e.g., by weighting (in the form of giving different significance to) previously generated edges between a pair of contexts represented as nodes in the context graph 220, etc.).

Architecture 200 can include memory/data stores 215 for storing and/or retrieving acquired data 220, other data 230, predicted data 235, and/or context graph 225. Memory/data stores 215 can include any type of memory known (e.g., volatile memory, non-volatile memory, etc.). Each of data 220, 230, 235, and 225 can be generated, processed, and/or captured by the other components in architecture 200. For example, acquired data 220, other data 230, predicted data 235, and/or the context graph 225 includes data generated by, captured by, processed by, or associated with one or more provider(s)/device(s) 260, service(s) 240, user messaging devices with sensor(s) 255, processing unit(s) 245, etc. Architecture 200 can also include a memory controller (not shown), which includes at least one electronic circuit that manages data flowing to and/or from the memory 215 The memory controller can be a separate processing unit or integrated in processing unit(s) 245.

Third party social network servers (205 and 260) such as a, cellular service provider servers that enable the sending and receiving of messages such as email messages, short message service (SMS) text messages, multimedia message service (MMS) messages, or any other device that enables individuals to communicate using any protocol and/or format.

Architecture 200 can include network-connected devices 250, which may include any number of hardware devices that communicate via any of the communication mechanism(s) 210 and are capable of being controlled via network communication. Examples of devices 250 include, but are not limited to, IoT devices, laptop computers, desktop computers, wearables, servers, vehicles, and any type of programmable device or computing system.

For one embodiment, Architecture 200 includes communication mechanism(s) 210. Communication mechanism(s) 210 can include a bus, a network, or a switch. When communication mechanism(s) 210 includes a bus, communication mechanism(s) 210 include a communication system that transfers data between components in architecture 200, or between components in architecture 200 and other components associated with other systems (not shown). As a bus, communication mechanism(s) 210 includes all related hardware components (wire, optical fiber, etc.) and/or software, including communication protocols. For one embodiment, communication mechanism(s) 210 can include an internal bus and/or an external bus. Moreover, communication mechanism(s) 210 can include a control bus, an address bus, and/or a data bus for communications associated with architecture 200. For one embodiment, communication mechanism(s) 210 can be a network or a switch. As a network, communication mechanism(s) 210 may be any network such as a local area network (LAN), a wide area network (WAN) such as the Internet, a fiber network, a storage network, or a combination thereof, wired or wireless. When communication mechanism(s) 210 includes a network, components in architecture 200 do not have to be physically co-located. When communication mechanism(s) 210 includes a switch (e.g., a “cross-bar” switch), separate components in architecture 200 may be linked directly over a network even though these components may not be physically located next to each other. For example, two or more of processing unit(s) 245, communication mechanism(s) 210, memory 215, and provider(s)/device(s) 260 are in distinct physical locations from each other and are communicatively coupled via communication mechanism(s) 210, which is a network or a switch that directly links these components over a network.

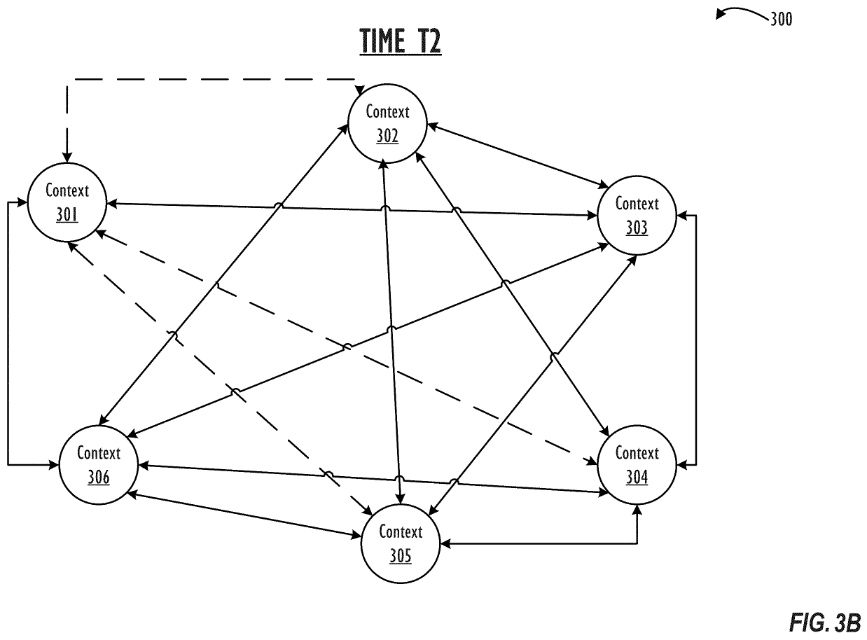

FIGS. 3A-3C illustrate, a 2D graphical approximation of an example multi-dimensional context graph 300 at three different times T1, T2, and T3, in accordance with one embodiment. Here, T3 occurs after T2 and T1, and T2 occurs after T1. The example context graph 300 in FIGS. 3A-3C can be generated and/or used by the embodiments of a smart message and thread notification, summarization, prioritization, and task list generation system as described herein (e.g., messaging infrastructure 120 described throughout this disclosure).

With specific regard now to FIG. 3A, a 2D graphical approximation of an example context graph 300 associated with a single user account at time T1 is illustrated. As shown, the context graph 300 includes one cluster of context (“context cluster”) comprised of six contexts 301-306. As used herein, a “context cluster,” a “cluster of contexts,” and their variations refers to a group of one or more contexts that is based on a relationship between the user account being serviced and a set of messages. In FIG. 3A, each of the contexts 301-306 in the context cluster of graph 300 is based on a relationship between User A (i.e., the user account being serviced), messages received by that user (e.g., a friend of User A, a service notification, a social media message, etc.), and attributes of User A (e.g., geolocation, time, device set on silent, meeting schedule, etc.). It is to be appreciated that there can be any number of contexts (i.e., at least one context) in the context graph 300 and that the context cluster in graph 300 can include any number of contexts.

Context graph 300, shown in FIG. 3A, includes several edges between the nodes representing contexts 301-306. Each of these edges represents a correlation between its pair of nodes. Furthermore, there can be different types of edges based on a degree of correlation between a pair of nodes (i.e., a pair of contexts). Additionally, each of the edges can be weighted to show a degree of correlation between its pair of nodes with a higher degree of correlation having a higher significance in terms of the weighting. Correlations between the contexts 301-306 (i.e., the nodes 301-306) in the graph 300 can be based on acquired data, relationships of messages, and/or predicted data. For one embodiment, one or more of acquired data, relationships, and/or predicted data is valued and combined to form the edge weight. For example, and as illustrated in FIG. 3A, the edges between one or more pairs of the contexts having differing thicknesses to show that the weighting of the correlations can be different.

Referring now to FIG. 3B, the graph 300 is illustrated at time T2, which occurs after time T1. As time moves from T1 to T2, the data associated with the user account evolves (i.e., changes, increases, reduces, etc.) and data relating to subject matter of messages also evolves. As shown in FIG. 3B, three edges are now represented using dotted lines at time T2 (as opposed to being represented using solid lines at time T1) while all other edges are illustrated using solid lines at time T2. In FIG. 3B, the edges represented by the dotted lines are different from the edges represented by the solid lines. For example, a first pair of nodes that is linked using a dotted line (e.g., nodes 301 and 302, etc.) is less correlated than a second pair of nodes that is linked using a solid line (e.g., nodes 301 and 303, etc.).

With regard now to FIG. 3C, context graph 300 is illustrated at time T3. Time T3 occurs after T2 such that the data associated with the user account evolves (i.e., changes, increases, reduces, etc.) as time proceeds from T1 to T3. As shown in FIG. 3C, only two edges are now represented using dotted lines at time T3 (as opposed to three edges being represented using dotted lines at time T2) while all other edges are illustrated using solid lines at time T3. As explained above, the dotted and solid lines show that the differing relationships between pairs of nodes in context graph 300. For a first example, and with regard to FIGS. 3B-3C, the correlation between context 301 and context 306 at time T2 is different from the correlation between context 301 and context 306 at time T3. In addition, the other one of the two dotted lines indicates that context 302 is no longer correlated with context 304. For a second example, and with regard to FIGS. 3B-3C, the correlation between context 302 and context 304 at time T2 is different from the correlation between context 302 and context 304 at time T3.

As shown in FIGS. 3A-3C, data stored in a context graph (e.g., context graph 300) can (and likely will) evolve over time. That is, correlations between contexts (e.g., correlations between messages, importance to user as reflected by user attributes, etc.) can change over time to reflect changes in the real world relative to the subject matter of the messages. In a simple case, older messages may be less relevant (e.g., less correlated) to a user's current context. This set of correlations can be used by the disclosed messaging infrastructure 120 to assist with improving the accuracy and efficiency of presenting thread information, message summarizations, predicted time durations for response, and priority assessments to a user.

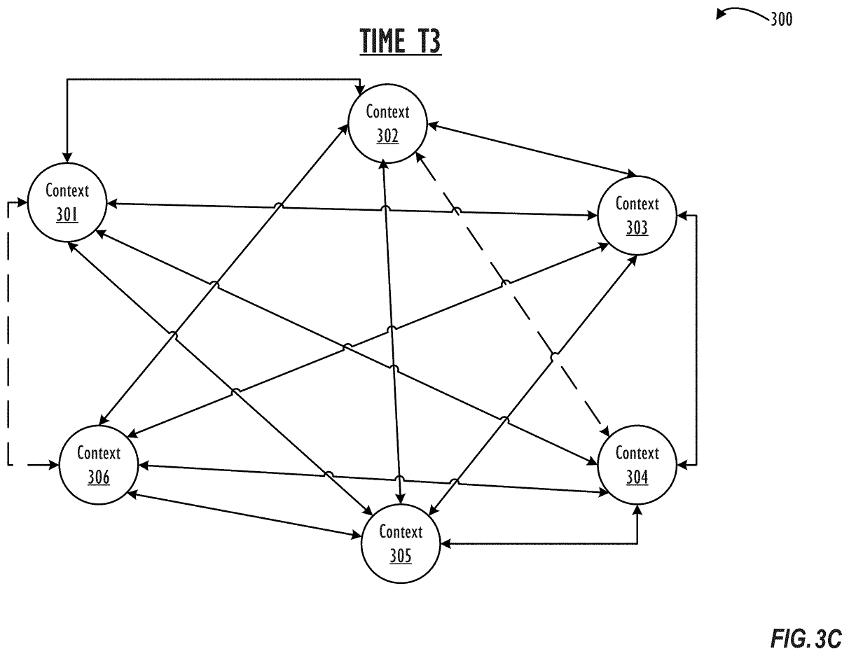

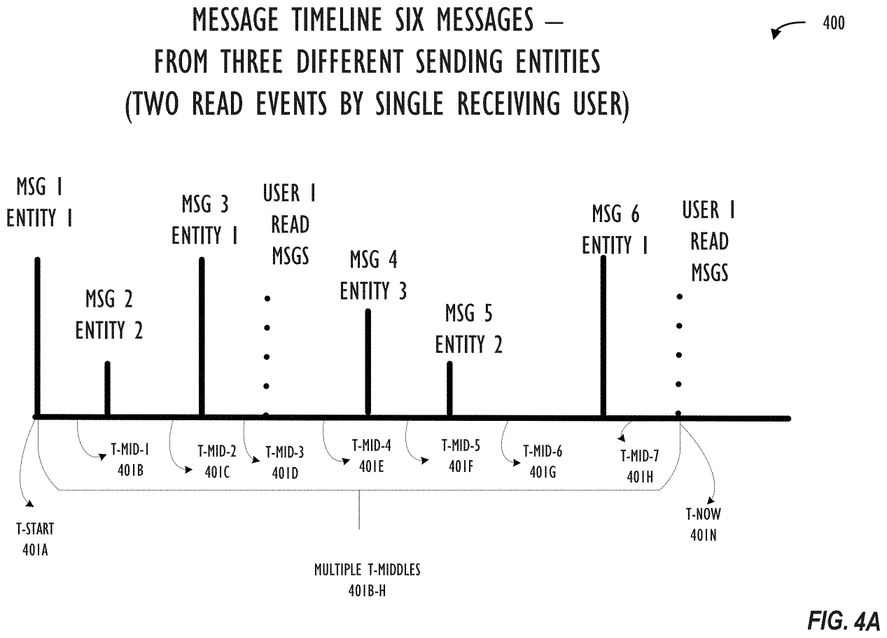

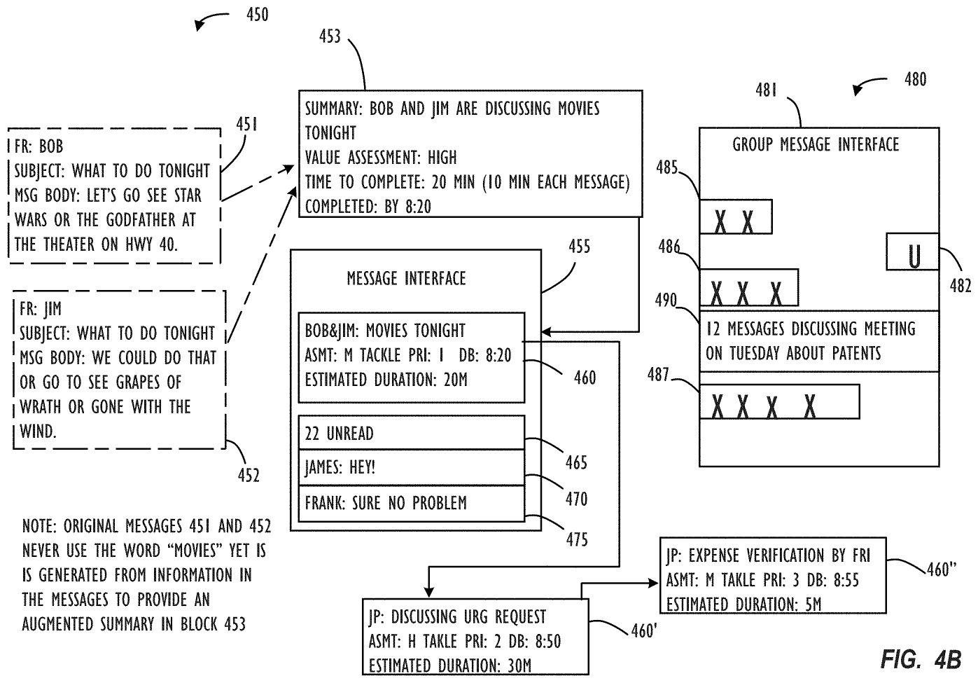

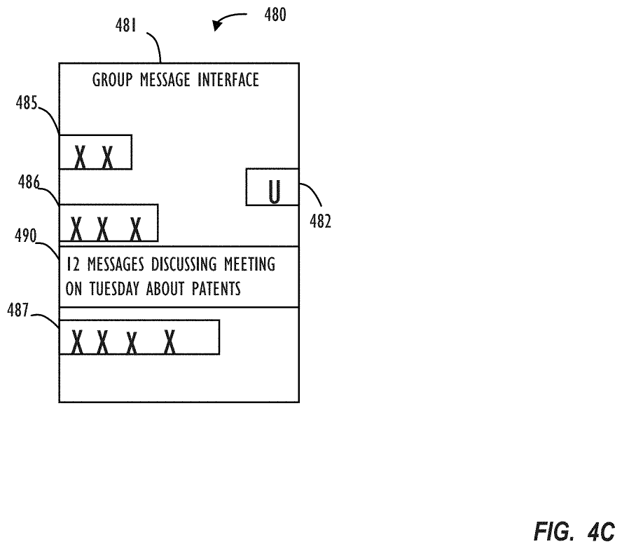

Referring to FIG. 4A, a message timeline 400 representing six messages from three different sending entities and two read events for a single receiving entity is illustrated. A passage of time is represented by the base horizontal line and vertical lines represent messages from each of three distinct entities (identified as Entity 1, Entity 2, and Entity 3). For simplicity, timeline 400 represents messages processed with respect to a single user. That is all six messages have been sent to the same user and possibly others but “others” are not depicted in timeline 400. There are two vertical dotted lines representing read events by a particular user. Timeline 400 represents a single user receiving messages from a plurality of entities over time and the intermittent nature in which users actually use a device to read messages. For example, the inherent time lapse between messages being sent and messages being read by the intended recipient. Timeline 400 begins at T-START 401A, continues through T-NOW 401N and progresses into the future. Vertical lines are shown at different lengths to allow easy distinction between different sending entities. For example, there are three long lines representing messages 1, 3, and 6 from Entity 1, two short lines representing messages 2 and 5 from Entity 2, and one medium length line representing message 4 from Entity 3. T-MID-1 401B through T-MID-7 401H represent intervals of time between the discrete events (i.e., vertical lines) of timeline 400.

Continuing with FIG. 4A, timeline 400 begins at T-START 401A where message 1 from Entity 1 is first available for processing at messaging service 240. For example, the message arrives at server 241A as a result of transmission across a network from a device associated with Entity 1 in route to a device associated with the message recipient(s). It is important to note that in the case of multiple recipients, each of those recipients will have associations with a unique set of contexts. As a result, each augmented summary, set of quick response actions, message value assessments, and/or time estimates may be customized and tuned on a per-user (e.g., recipient) basis. Processing of message 1 may begin upon receipt and continue through time periods T-MID-1 401B, T-MID-2 401C, and T-MID-3 401D until a user activates a device or application to read that message. Clearly, processing may not take that entire duration, however, because contexts change over time, it may be desirable to perform two sets of processing. The first set of processing which may represent the bulk of processing may take place immediately upon receipt (e.g., T-START 401A) and proceed to completion. A second set of processing may optionally be performed immediately prior to presentation to the recipient. That is, the second set of processing may initiate as soon as an indication that a user is picking up a mobile device or activating an application related to reading messages. This second set of processing may update information to be presented to the user based on changes since the first set of processing completed. In this manner, a user is presented the most up to date information relative to any context changes. For performance reasons, processing may also be performed periodically between the first set of processing and the second set of processing to minimize the amount of time the second set of processing will require.

Continuing with timeline 400, message 2 from Entity 2 is first available for processing at messaging service 240 at the end of T-MID-1 401B. Processing of message 2 begins with messaging service 240 having already processed and updated information based on receipt of message 1. Accordingly, the processing of message 2 takes into account information made available directly (hard data) or indirectly (soft data) from message 1. Processing of message 2 is performed in time periods T-MID-2 401C and T-MID-3 401D in a similar manner to that described above for message 1. In the example of timeline 400, at the end of time period T-MID-2 401C, message 3 is first available for processing at messaging service 240. Processing of message 3 is performed in a similar manner to processing of messages 1 and 2 and may take into account updates based on information determined from both messages 1 and 2. At the end of time period T-MID-3 401D, a first read event is shown. As a result of the read event (e.g., user picks up phone, launches an application) update processing for each of messages 1, 2, and 3 may be performed (i.e., the second set of processing for each messages as discussed above). Note, it is possible that a user does not actually read any or all of messages 1, 2, or 3 in an action related to this read event. In that case, any unread messages may continue to be processed until a next read event when they are actually marked read. For any message that is actually read, message processing service 240 may stop maintaining an automatically generated augmented summary, auto-response options, value assessments, or time estimates after they have been presented to the user as part of reading their associated message. Timeline 400 continues in a similar manner with messages 4, 5, and 6. Each of these is processed in turn taking into account information and context updates from any previous messages. Further, if processing of a subsequent message affects a context associated with a previous message, processing of the previous message may be performed again to take into account any context changes. That is, any message that may affect a previously generated augmented summary, auto-response option, value assessment, or time estimate may cause the system to update information that has not yet been presented to the user. Finally, at time T-NOW 401N, there is a second read event and just-in-time processing of each unread message may be performed. For this example, consider that the user has completed reading all of messages 1-6 (and been presented with appropriate summaries, auto-response options, value assessments, and/or time estimates). Accordingly, processing for each of these messages 1-6 may be halted (some messages 1-3 may have already been halted if read at the first read event). Of course, the contexts associated with each of these historical messages are still available and may be used as part of processing for any future message.

Referring now to FIG. 4B, two block diagrams 450 and 480 are illustrated. Block diagram 450 illustrates a set of messages 451 and 452, their corresponding summary 453 (which may include their value assessments and time estimates), and a possible message interface 455. Block diagram 480 illustrates a possible group message interface 481. Although these are shown as two different interfaces 455 and 481, they could be combined on a single interface display. In block diagram 450, message 451 is from Bob and has a subject of “what to do tonight.” The message body describes specific movies and a theater. Message 452 is considered to be in the same thread (or related by a high-value context) and mentions two different movies. Note that neither of the two original messages mention the word “movies” but instead mention well recognizable movie titles and the word “theater.” Block 453 represents a possible automatically generated summary of the two messages that may be “built” from intelligent (e.g., machine learning) analysis of messages 451 and 452, and of historical user events and behaviors by a message processing service 240 according to disclosed embodiments.

Block 455 represents a possible message interface where element 460 represents presentation of the augmented summary followed by a priority assessment of “medium” indicated as “ASMT: M,” a tackle priority (e.g., priority to address the message) of 1 indicated as “TACKLE PM: 1,” a done by time of 8:20 indicated as “DB: 8:20,” and an estimated duration of 20 minutes. In this example, the current time is 8:00 so if the user started to act on that task now it would be completed by an estimated time of 8:20. Block 460′ indicates another message (or message group) that has a summary of JP discussing an urgent request. However, even though JP believes the request is urgent, the prioritization system may automatically determine to prioritize this as a tackle priority of 2. Thus, JP's message has a tackle priority lower than the discussion about movies tonight. This “apparently” higher priority message may be determined to be actually a lower priority message than a priority provided by JP because of several factors. Firstly, JP may always think his requests are urgent when they are, in reality, not urgent at all (however this assessment as shown in block 460′ is in fact “H” for high which is set by the system and may only use JP's input as a suggestion). Secondly, JP's request indicates that it takes 30 minutes to complete and this user may not be available for the next 30 minutes. Therefore, if the user only has a 20 minute window at this time, it would be a more efficient use of time to address the 20 minute task that can be completed rather than starting a task that cannot be completed. Further still, JP's request may be an urgent request but cannot be completed until the next day because a dependency to complete that task may not be currently available. For example, it may require interfacing with a bank that is not currently open. Numerous factors may be known to the system to assist in efficiently tuning a task list (e.g., based on tackle priority) for a user. Block 460″ illustrates a third message (or message group) that indicates a 5 minute time to complete, a complete by time of 8:55 (assuming tasks are performed in tackle priority order), a priority assessment of “M” for medium, and a tackle priority of 3 (indicating it is recommended to do this task third out of our three example messages). In this manner a user may receive an automated and prioritized task list generated by a system that has an extensive knowledge base of dependencies related to actual task completion criteria. The system may be aware of other people's schedules, and other task scheduling information. For example, a user may receive a recommendation to complete a low priority task because completion of that task will allow three other people to continue with a task that was paused while waiting for an action (e.g., simple approval) from the user.

Also illustrated in message interface 455 is included block 465 which indicates an unread message count, and blocks 470 and 475 that represent traditional summary views for messages that, in this example, require no augmentation based on their simple nature and analysis of their context.

Continuing to FIG. 4C, block diagram 480 illustrates a possible group message interface 481. In this interface, a plurality of “conversations” are depicted with input to the conversation from others represented by blocks 485, 486 and 487 that are left oriented and input from to the conversation from the user depicted by block 482 that is right oriented. Block 490 represents a summary of a conversation. Upon selection, any of these indicators may reveal the conversation thread that they are referencing. The relative lengths or other indications (e.g., number of X's) could indicate the number of participants in the group and/or the number of active participants in the group. Further details about conversational message and techniques to monitor and interact with them is discussed in “Methods and Systems to Support Adaptive Multi-Participant Thread Monitoring,” incorporated by reference above.

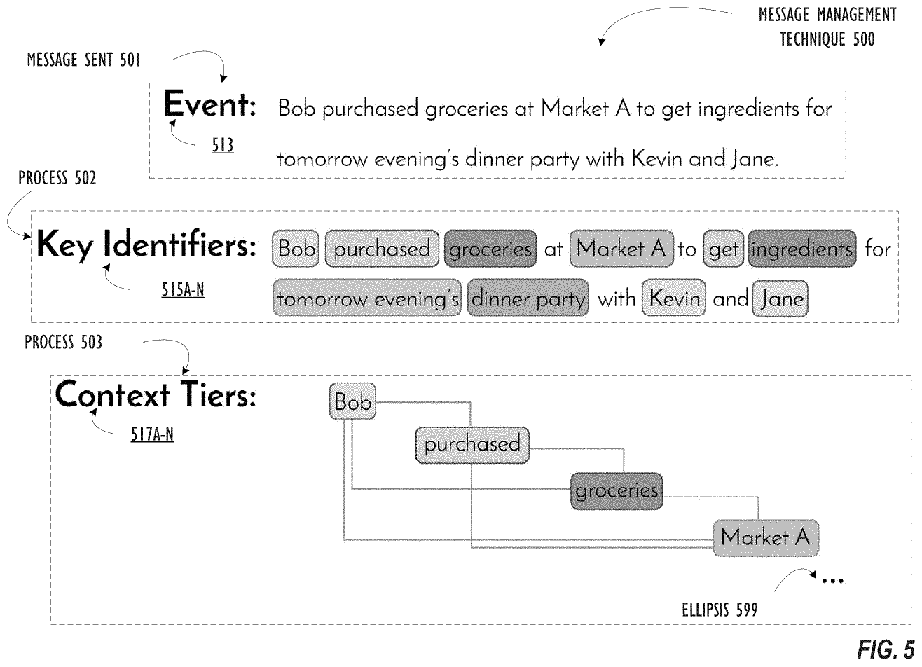

FIG. 5 illustrates a tiered message management technique 500 in accordance with one or more embodiments. Technique 500 can be performed by a message processing service (e.g., message processing service 240 described above in connection with FIG. 2, etc.). Technique 500 begins at operation 501, where a message is sent by another user and received by a message processing service. The event 513 includes text from the message and represents, in this example, activity associated with a user (e.g., user Bob shown in FIG. 5, etc.). For one embodiment, the messaging service receives the message 513 as a result of operation 501. For one embodiment, operation 501 may include the messaging service pre-processing the event 513 to convert the event 513 into a format that is usable by the messaging service. For example, the messaging service can format the event 513 into a data structure that is similar to the data structure used for organizing a user's contexts in a context graph.

Technique 500 proceeds to operation 502. Here, the messaging service can process event 513 to determine one or more key identifiers 515A-N associated with the event 513. These key identifiers can be parsed and ascertained via natural language principles and/or machine learning techniques implemented by the messaging service. As shown in FIG. 5, key identifiers 515A-N are encompassed by the rounded squares.

Next, technique 500 proceeds to operation 503. Here, the messaging service determines whether one or more of the key identifiers 515A-N is associated with a context. For example, each of the key identifiers 515A-N may be associated with a context that is represented as a node in a context graph, such that identification of the key identifier triggers identification of the corresponding context 517A-N within the context graph. For a first example, and for one embodiment, the key identifier “Bob” can trigger identification of a context associated with all activities performed by the user Bob in a context graph. For a second example, and for one embodiment, the key identifier “purchased” can trigger identification of a context associated with all activities associated with purchasing items and/or services performed by the user Bob in the context graph. For a third example, and for one embodiment, the key identifier “groceries” can trigger identification of a context associated with all activities associated with purchasing or selling groceries performed by the user Bob in the context graph. For a fourth example, and for one embodiment, the key identifier “Market A” can trigger identification of a context associated with all activities associated with user Bob's physical and/or virtual interactions with Market A in the context graph.

For one embodiment, the messaging service organizes the identified contexts into a hierarchical context tier based on relative granularity levels of the contexts when compared to each other. Here, the messaging service can cache the at least some of the identified contexts and/or the generated context tier to retrieve or access the information without having traverse the context graph. This can, in some embodiments, assist with efficient utilization of computing resources and improve the accuracy associated with proper resolution of user requests. This can also assist with intelligently responding to user requests in a more efficient and accurate manner than was previously available with pre-defined auto-response options; moreover, it can assist with providing realistic assessments of the value of individual messages based on their context and their content. For example, and as illustrated in FIG. 5, the messaging service can arrange the identified contexts in a tier such that the contexts are traversed in a sequential order. Conceptually, a context tier will include the more narrowly defined micro-contexts being stacked on top of the more broadly defined macro-contexts. As shown, the foundation tier is context “Bob”, which includes all activities associated with user Bob. The penultimate level is the context “purchased”, which includes all purchase activities associated with user Bob. The level above the penultimate level is context “groceries”, which includes all purchase activities associated with groceries as those activities relate to user Bob. The top-most level is context “Market A”, which includes all purchases activities performed by user Bob in Market A. The ellipsis 599 in FIG. 5 shows that the messaging service can arrange any number of contexts associated with the event 513 into a context tier.

For some embodiments, the context tier is not hierarchical. That is, each context might be related to all other contexts or no other contexts. This may be the case when a single message is processed based on its contents alone and does not get associated with any previously defined contexts. It is, in fact, a self-contained context.

It is to be noted that, in any of the examples of this disclosure, the message value assessment is preferably made independently for any given user, as reflected in the foregoing discussion of a unique context graph 225 being maintained for any user within the system. For example, a particular message may be addressed from a sender to multiple recipients, yet the importance and priority of such a message (hence, its value assessment) may be different for each recipient.

Moreover, it is to be recognized that the message value assessment metric itself is preferably customizable or “tunable” on a per-user basis. That is, based upon one or more contextual factors—either soft data or hard data—different valuation metrics will be appropriate for different users and entities within an overall implementation. Moreover, it is contemplated that the message value assignment metric for any given user may be customizable or “tunable” on a temporally dynamic basis. Such modifications may be made based upon explicit user intervention and/or upon hard or soft data as it is incorporated into context graph 225.

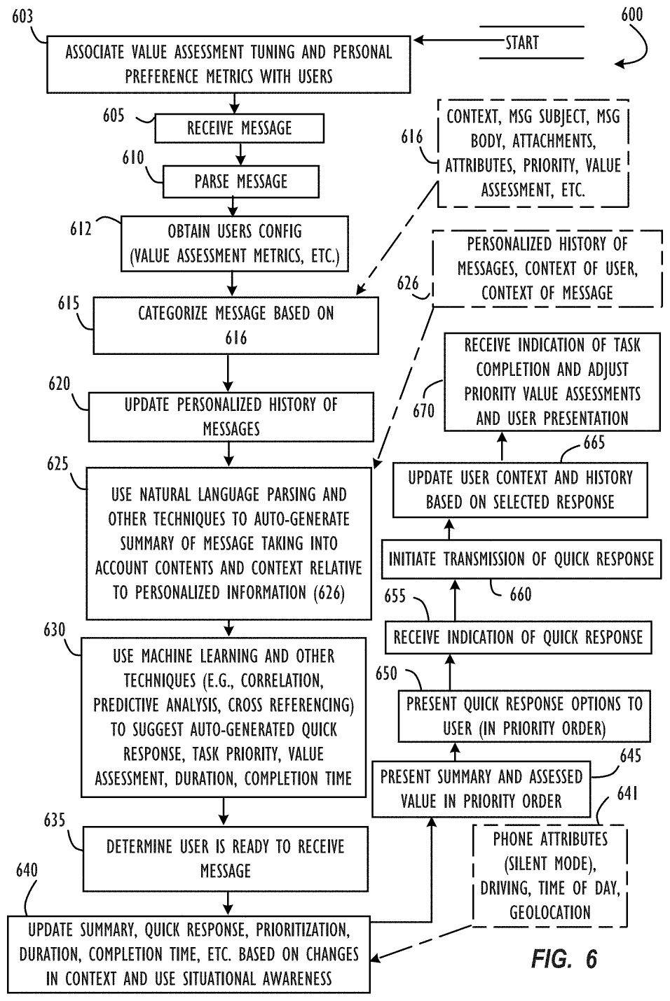

FIG. 6 illustrates, in flowchart form, operation 600 providing one example process that may be performed by messaging service 240. Beginning at block 603, messaging service 240 preferably assigns a value assessment tuning metric to each user, whereby message value assessments can be made based on personal preferences, which might be based on status, for each user. For example, the CEO of a corporation might adjust the system to value his time over that of his direct reports, whereas a line manager may want to perform his actions to best facilitate activities of his direct reports (and thus increase overall efficiency of his team). That is, the CEO knows that his direct reports can be more trusted to manage on their own without his involvement, whereas, the line manager may represent an integral part of the productivity of his direct reports. It is contemplated that a single value assessment metric may be assigned to all users of messaging service 240; alternatively, messaging service 240 may tune or customize a value assessment metric to be assigned to each user or to each user within a predetermined class or subset of users. Furthermore, it is contemplated that each user's value assessment metric may be dynamically modified throughout operation of messaging service 240.

At block 605, a message is received at messaging service 240. Block 610 indicates that contents of the message may be parsed to determine a context (or contexts) with which to associate this message. As noted above, and without limiting the above, a message's context may reflect any and all of a number of different variable factors, also referred to herein as “context variables,” including, without any limitation, the content of the message; the nature and content of any attachments to the message; the identity of both the sender and recipient(s) of the message (and in turn, any known relationships between the sender and recipient(s)); references or associations specifically or implicitly found to exist between a particular message, including its attachments, and previously processed messages; the temporal relationship which may exist between a sequence of messages which are determined to be related; and so on. Block 612 indicates that a user's configuration that may include, among other things, their unique value assessment metrics, may be obtained for use in further processing.

Block 615 indicates that the message may be categorized, in part, by using elements identified in block 616, to determine if any associations of this message exist with other messages for this user. Block 620 indicates that a personalized history (e.g., per-user) of messages may be updated based on information identified in the newly received message. Block 625 indicates that natural language processing (NLP) and other techniques may be used to auto-generate an augmented summary of the newly received message using previously available information (see block 626). Note that an augmented summary refers to a summary that is not merely extracted from contents of the message, but includes at least one portion of information generated using another source of information in addition to the actual message contents, for example, using data 220, 230, 235, or context 225 discussed above with the discussion of FIG. 2. Block 630 indicates that machine learning techniques and other data processing techniques may be used to suggest auto-generated quick response options for a user, in addition to generating the augmented summary as described with reference to block 625. The generation of an augmented summary and proposed quick-response options for the user are described in the above-referenced “Methods and Systems to Support Smart Message and Thread Notification and Summarization” patent application.

Block 630 indicates that machine learning techniques and other data processing techniques may also be used to calculate an assessment of a value associated with the message. As used herein, the term “value” as applied to a message refers to a metric—that is, a system or standard of measurement—which can be assigned to a message reflecting the message's relative priority and importance to the recipient, the time and effort on the part of the recipient that may be implicated by the content of the message, and/or the potential efficiency realized once the message is acted upon by the recipient, among other factors. A value metric for assessing a message value in accordance with this disclosure may take into account, i.e., be a function of, a plurality of variables including, by way of example but not limitation, any or all factors involved in the creation of context graph 225 as described above, including without limitation: temporal and positional considerations (i.e., when and where a message was sent or received); an assessment of the content and complexity of the message itself; whether the message includes attachments, and if so, the nature of such attachments; any specific actions on the part of the recipient(s) that the message may entail; the relation of the message to others, temporally and substantively; the relation of the message recipient(s) to the sender and to other entities; and others.

Block 630 also indicates that machine learning techniques and other data processing techniques may also be used to calculate an estimated time for processing the message. For example, past performance on this type of task, similar tasks, or similar users within the scope of any implementation may be an indication of an estimated time for processing the message. As used herein, the terms “process time” and variants thereof as applied to a message refers to the time that a user will be required for a user to accomplish, without limitation: (i) reading the message itself; (ii) viewing and/or reading any attachments to the message; (iii) performing any tasks either implicitly or explicitly called for by the context of, content of, or attachments to the message; (iv) preparing and sending a response to the message, either in the form of a responsive message or otherwise, and including creation or editing of any attachments to a response.

With respect to time estimation, it is contemplated that the machine learning capabilities of message processing/logic modules 246 (previously described with reference to FIG. 2) can be of particular utility. For example, the determination of any implicitly-referenced tasks in a message and/or its attachment(s) may be discerned in a manner similar to the example described with reference to FIG. 4B, wherein the summary 453 reflects “movies” whereas the underlying messages (451, 452) mention only movie titles. Thus, the time estimate for a message which states “here is a draft of the contract for your review” can, e.g., through machine learning and other processing techniques, be based on such factors as the nature and size of an attachment to the message and other historical information which can be gleaned about the users, their previous interactions, their previous messages, and so on.

As will be appreciated by persons of ordinary skill in the relevant arts and having the benefit of the present disclosure, much of the information (hard data and soft data) useful to assess a message's value according a metric, as well as to estimate a user's processing time for a message, is embodied in the context graph 225 established and maintained as described herein. It is contemplated that a value metric as described herein may be represented and presented in various ways, including, without limitation, numerically (e.g., 1, 2, . . . N), symbolically (e.g., a “star” rating), or in some other hierarchical manner. Moreover, a message's value relative to others may be reflected simply by the order in which a plurality of messages are presented to the recipient. Similarly, time estimates may be provided either quantitatively (seconds, minutes, hours, etc. . . . ) or relatively, e.g., numerically/sequentially ordered according to estimate time for processing.

As an illustration, and with continued reference to FIG. 6, if a user is driving and an email asking a question is received, the answer to the question may be available within the user's personalized history of information. As a result, an auto-generated quick response may allow the user to answer the question by making a single selection rather than typing an answer. A concurrently displayed value assessment can provide the user with insight as to the priority the recipient should be prepared to give the message. Part of the user's insight may further be based upon time estimates provided with messages. Block 635 indicates that a user is believed to be ready to receive pending messages including this message, for example, the read-event mentioned above for FIG. 4. Block 640 indicates that, as a result of a read-event, the summary, value assessment, and quick-response information may be updated based on intervening information (e.g., between send time and now) and situational awareness (see block 641) of the user about to read. That is, summaries may be different (e.g., shorter) if a user is driving and more possible auto-response options may be generated if the user is driving (as opposed to being sitting at a desk). Block 645 indicates that the summary (e.g., augmented summary) may be presented to the user, along with an indication of assessed value of the message and an estimate of the time required for the user to process the message.

Block 650 indicates that quick response options, which may be ordered based on a determined tackle priority based, in part, on the value assessment, may be presented to the user. Block 655 indicates that the user has selected either an automatically generated quick-response or possibly a pre-defined quick-response and block 660 indicates that the selected quick-response is transmitted. Block 665 indicates that contexts may be updated and historical information updated to take into account the information conveyed in the selected quick response. Similarly, although not shown in the Figures, outgoing emails may be processed for updates to context information and personal history information. In this manner, message processing service 240 has a complete picture of information provided by in-bound and out-bound messages associated with each user.

Example operation 600 ends with block 675 with a system possibly providing information to indicate that an underlying task associated with a context, tackle priority, etc. may have been completed by this user or even another user and an adjustment of the priority assessment may take place. Further, this completion information may include time to complete the task that may be used in later predictive assessments when a similar task is identified. By tracking completion times of tasks and tuning predictive assessments based on actual completion times (either by this user or by one or more other users faced with the same or a similar task) future predictive assessments may be more accurate.

The assessment of a message's value may be further appreciated through consideration of the following case example:

A recipient (Recipient) receives a plurality of messages between read events.
a. Message 1 comprises a simple message body (text) but includes an attachment that through previous categorization and processing steps (e.g., blocks 615, 625, and 630) is determined to be likely time-consuming to process.
b. Message 2 comprises a simple message body (text) and includes an attached picture/image document;
c. Message 3 comprises a message body (text) including a request that the recipient review and sign an attached document
d. Message 4 comprises a message body (text) requesting an approval by means of a yes/no response and possibly forwarding to a further recipient.

In this example, the likely amount of time that will be required for the recipient to process each message will differ, and it is contemplated that the parsing, categorization, natural language, and machine learning processes described herein can enable the system to predict or assess such differences. Message 1, for example, may be assessed as being anticipated to take a substantial amount of time, given the complex attachment, whereas Message 2 may be assessed as being anticipated to be comparatively easily (and quickly) handled, e.g., by viewing the attached image and perhaps selecting a proposed quick response generated by the system. Message 3 may be assessed as being likely to involve a certain amount of time for review of the attached document, whereas Message 4 may be assessed as being capable of handling/processing in a relatively short period of time by reading and forwarding the message.

Another case example further illustrates how the assessment of a message's value may be assessed:
a. A higher-level employee who oversees a number of lower-level employees receives a message from one such lower-level employee regarding an issue of concern.
b. The issue of concern was brought to the attention of the lower-level employee through multiple initial messages the lower-level employee received from a number of subordinates under his/her supervision.
c. Each of the multiple initial messages was sent to both the lower-level and the higher-level manager.

In such a scenario, it may be the case that the lower-level employee has primary responsibility for addressing the issue of concern, but must obtain instructions or approval from the higher-level employee before doing so. Thus, optimally, a communication from the lower-level employee to the higher-level employee concerning the issue would be assessed with a relatively higher value (as presented to the higher-level employee) than the multiple communications from the subordinates that were also sent (e.g., cc-ed) to the higher-level employee. This would lead to an expeditious reply from the higher-level employee to the lower-level employee, enabling the lower-level employee to address the issue of concern. On the other hand, the messages from the subordinates would optimally be either singly or collectively assessed a relatively high priority (as presented to the lower-level employee), reflecting an issue of concern to the subordinates, it being the lower-level employee's ultimate responsibility to address the issue.

The assessment of providing a processing time estimate may be further appreciated through consideration of the following case example:
(a) A user receives a first message which is assigned a relatively high value assessment, but which also is estimated to require several hours of the user's time to process.
(b) Before any read event, the user receives multiple messages with relatively low priority assessments, each of which being estimated to require very little of the user's time to process (e.g., by selecting from a list of proposed quick responses).
(c) Also before any read event, the user receives a message with a relatively moderate (i.e., between high and low) priority assessment, and with a time estimate less than any message given a high priority assessment.

In this example, upon a read event, a user may, in the interests of overall efficiency, elect to process the relatively low-priority messages even before processing the highest-priority message. On the other hand, the user may next elect to process the highest priority message, even though such processing may take more time than processing the medium-priority message. As this example illustrates, the value assessment and time estimation of messages together provide the user with insight and the potential for efficiency that either one of these features provides by itself.

To continue this example, consider a variation in which, prior to the read event occurring, an additional message is received, which indicates that some aspect of the medium-priority message has changed, causing the time estimate for that message to be substantially reduced. In such a case, upon the read event, the user may elect to process both the lower-priority messages and the medium-priority message before processing the highest-priority message. This further illustrates the dynamic and synergistic potential that is afforded by providing both value assessments and time estimates in accordance with this disclosure.

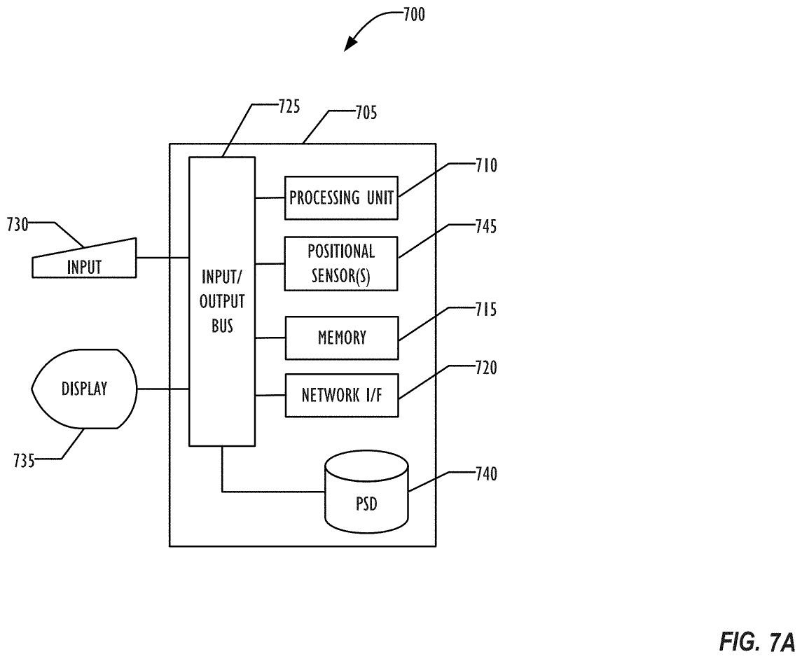

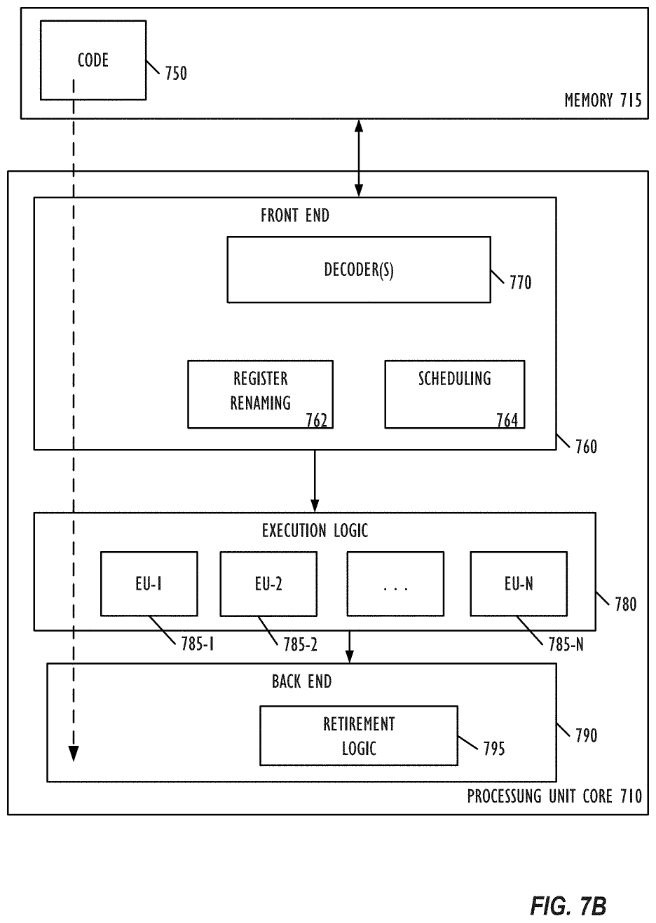

Referring now to FIG. 7A, an example processing device 700 for use in the communication systems described herein according to one embodiment is illustrated in block diagram form. Processing device 700 may serve in, e.g., a mobile phone 107, end user computer 103, sync server 105, or a server computer 106-109. Example processing device 700 comprises a system unit 705 which may be optionally connected to an input device 730 (e.g., keyboard, mouse, touch screen, etc.) and display 735. A program storage device (PSD) 740 (sometimes referred to as a hard disk, flash memory, or non-transitory computer readable medium) is included with the system unit 705. Also included with system unit 705 may be a network interface 770 for communication via a network (either cellular or computer) with other mobile and/or embedded devices (not shown). Network interface 770 may be included within system unit 705 or be external to system unit 705. In either case, system unit 705 will be communicatively coupled to network interface 770. Program storage device 740 represents any form of non-volatile storage including, but not limited to, all forms of optical and magnetic memory, including solid-state storage elements, including removable media, and may be included within system unit 705 or be external to system unit 705. Program storage device 740 may be used for storage of software to control system unit 705, data for use by the processing device 700, or both.

System unit 705 may be programmed to perform methods in accordance with this disclosure. System unit 705 comprises one or more processing units, input-output (I/O) bus 775 and memory 715. Access to memory 715 can be accomplished using the communication bus 775. Processing unit 710 may include any programmable controller device including, for example, a mainframe processor, a mobile phone processor, or, as examples, one or more members of the INTEL® ATOM™, INTEL® XEON™, and INTEL® CORE™ processor families from Intel Corporation and the Cortex and ARM processor families from ARM. (INTEL, INTEL ATOM, XEON, and CORE are trademarks of the Intel Corporation. CORTEX is a registered trademark of the ARM Limited Corporation. ARM is a registered trademark of the ARM Limited Company). Memory 715 may include one or more memory modules and comprise random access memory (RAM), read only memory (ROM), programmable read only memory (PROM), programmable read-write memory, and solid-state memory. As also shown in FIG. 7A, system unit 705 may also include one or more positional sensors 745, which may comprise an accelerometer, gyrometer, global positioning system (GPS) device, or the like, and which may be used to track the movement of user client devices.

Referring now to FIG. 7B, a processing unit core 710 is illustrated in further detail, according to one embodiment. Processing unit core 710 may be the core for any type of processor, such as a micro-processor, an embedded processor, a digital signal processor (DSP), a network processor, or other device to execute code. Although only one processing unit core 710 is illustrated in FIG. 7B, a processing element may alternatively include more than one of the processing unit core 710 illustrated in FIG. 7B. Processing unit core 710 may be a single-threaded core or, for at least one embodiment, the processing unit core 710 may be multithreaded, in that, it may include more than one hardware thread context (or “logical processor”) per core.

FIG. 7B also illustrates a memory 715 coupled to the processing unit core 710. The memory 715 may be any of a wide variety of memories (including various layers of memory hierarchy), as are known or otherwise available to those of skill in the art. The memory 715 may include one or more code instruction(s) 750 to be executed by the processing unit core 710. The processing unit core 710 follows a program sequence of instructions indicated by the code 750. Each instruction enters a front end portion 760 and is processed by one or more decoders 770. The decoder may generate as its output a micro operation such as a fixed width micro operation in a predefined format, or may generate other instructions, microinstructions, or control signals which reflect the original code instruction. The front end 760 may also include register renaming logic 762 and scheduling logic 764, which generally allocate resources and queue the operation corresponding to the convert instruction for execution.

The processing unit core 710 is shown including execution logic 780 having a set of execution units 785-1 through 785-N. Some embodiments may include a number of execution units dedicated to specific functions or sets of functions. Other embodiments may include only one execution unit or one execution unit that can perform a particular function. The execution logic 780 performs the operations specified by code instructions.

After completion of execution of the operations specified by the code instructions, back end logic 790 retires the instructions of the code 750. In one embodiment, the processing unit core 710 allows out of order execution but requires in order retirement of instructions. Retirement logic 795 may take a variety of forms as known to those of skill in the art (e.g., re-order buffers or the like). In this manner, the processing unit core 710 is transformed during execution of the code 750, at least in terms of the output generated by the decoder, the hardware registers and tables utilized by the register renaming logic 762, and any registers (not shown) modified by the execution logic 780.

Although not illustrated in FIG. 7B, a processing element may include other elements on chip with the processing unit core 710. For example, a processing element may include memory control logic along with the processing unit core 710. The processing element may include I/O control logic and/or may include I/O control logic integrated with memory control logic. The processing element may also include one or more caches.

Note that while system 700 is illustrated with various components of a data processing system, it is not intended to represent any particular architecture or manner of interconnecting the components; as such, details are not germane to the embodiments described herein. It will also be appreciated that network computers, handheld computers, mobile phones, servers, and/or other data processing systems, which have fewer components or additional components, may also be used with the embodiments described herein.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

In the foregoing description, numerous specific details are set forth, such as specific configurations, dimensions and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

Although operations or methods are described above in terms of some sequential operations, it should be appreciated that some of the operations described may be performed in a different order. Moreover, some operations may be performed in parallel rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components. Thus, it will be evident that various modifications may be made thereto without departing from the broader spirit and scope of at least one of the disclosed concepts set forth in the following claims. The specification and drawings are, accordingly, to be regarded in an illustrative sense rather than a restrictive sense.

In the development of any actual implementation of one or more of the disclosed concepts (e.g., such as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the disclosed concepts set forth in the embodiments described herein. Such development efforts might be complex and time-consuming, but may still be a routine undertaking for a person having ordinary skill in the art in the design and/or implementation of one or more of the inventive concepts set forth in the embodiments described herein.

One aspect of the present technology is the gathering and use of data available from various sources to improve the operation of the interactive interfaces. The present disclosure contemplates that in some instances, this gathered data may include personal information data that uniquely identifies a specific person. Such personal information data can include demographic data, location-based data, telephone numbers, email addresses, twitter ID's, home addresses, or any other identifying information.

What is claimed is:

1. A computer-implemented method, comprising:
receiving a first message at a first device, the first message from a first sending entity sent to a first user;
parsing the first message to identify key identifiers within the first message;
categorizing the first message based on the key identifiers, wherein categorizing includes associating the first message with at least one first context, the first context stored in a memory and forming an association of multiple messages related to each other based, in part, on content or subject matter references of each message;
generating a value assessment for the first message, the value assessment based on a value assessment metric, wherein the value assessment metric is based on a plurality of context variables and indicates a predicted priority level or importance level with respect to the first user acting in response to the first message;
determining the first user is accessing a user device; and
presenting said value assessment associated with a presentation of the first message on the user device.

2. The computer-implemented method of claim 1, further comprising:
generating a user processing time estimate to predict a time duration for the first user completing an act in response to the first message; and
presenting the user processing time estimate of the first message with the presentation of the first message on the user device.

3. The method of claim 2, further comprising:
receiving a second message at the first device, the second message sent after the first message and from the first sending entity to the first user; and
updating the user processing time estimate for the first message based on information derived from the second message.

4. The computer-implemented method of claim 3, further comprising:
performing the updating as a just-in-time update of the user processing time estimate of the first message after determining the first user is accessing the user device and prior to presenting the time estimate of the first message on the user device.

5. The computer-implemented method of claim 3, further comprising:
updating the user processing time estimate in a time period between receiving the second message and determining the first user is accessing the user device.

6. The method of claim 2, further comprising:
receiving a plurality of messages at the first device, the plurality of messages sent after the first message, the plurality of messages from a plurality of sending entities sent to the first user;
associating each of the plurality of messages with at least one of a plurality of contexts based on information determined using contents of each of the plurality of messages;
determining which of the plurality of messages are associated with a context related to the first message to create a set of messages related to the first message; and
updating the user processing time estimate of the first message based on information derived from at least two messages selected from the set of messages related to the first message.

7. The computer-implemented method of claim 2, further comprising:
receiving an indication of at least partial completion of an action related to the first message, the at least partial completion of the action performed by an individual other than the first user; and
updating both the value assessment and the user processing time estimate of the first message based on the at least partial completion of the action.

8. The computer-implemented method of claim 1, wherein said value assessment metric is tuned based on a per-user configuration setting based on reporting relationships between the first user and other users.

9. The computer-implemented method of claim 1, further comprising:
updating the value assessment of the first message after determining the first user is accessing the user device and prior to presenting the value assessment of the first message on the user device.

10. The computer-implemented method of claim 1, further comprising:
receiving a second message at the first device, the second message sent after the first message and from the first sending entity to the first user; and
updating the value assessment of the first message based on information derived from the second message.

11. The computer-implemented method of claim 10, wherein updating the value assessment occurs in a time period between receiving the second message and determining the first user is accessing the user device.

12. The computer-implemented method of claim 1, further comprising:
receiving a plurality of messages at the first device, the plurality of messages sent after the first message, the plurality of messages from a plurality of sending entities sent to the first user;
associating each of the plurality of messages with at least one of a plurality of contexts based on information determined using contents of each of the plurality of messages;
determining which of the plurality of messages are associated with a context related to the first message to create a set of messages related to the first message; and
updating the value assessment of the first message based on information derived from at least two messages selected from the set of messages related to the first message.

13. A non-transitory computer-readable medium comprising computer-executable instructions stored thereon, that when executed by one or more processing units, cause the one or more processing units to:
receive a first message at a first device, the first message from a first sending entity sent to a first user;
parse the first message to identify key identifiers within the first message;
categorize the first message based on the key identifiers, wherein categorizing includes associating the first message with at least one first context, the first context stored in a memory and forming an association of multiple messages related to each other based, in part, on content or subject matter references of each message;
generate a value assessment for the first message, the value assessment based on a value assessment metric, wherein the value assessment metric is based on a plurality of context variables and indicates a predicted priority level or importance level with respect to the first user acting in response to the first message;
determine the first user is accessing a user device; and
present said value assessment associated with a presentation of the first message on the user device.

14. The non-transitory computer-readable medium of claim 13, wherein the computer-executable instructions further comprise computer executable instructions to cause the one or more processing units to:
generate a user processing time estimate to predict a time duration for the first user completing an act in response to the first message; and
present the user processing time estimate of the first message with the presentation of the first message on the user device.

15. The non-transitory computer-readable medium of claim 14, wherein the computer-executable instructions further comprise computer executable instructions to cause the one or more processing units to:
receive a second message at the first device, the second message sent after the first message and from the first sending entity to the first user; and
update the user processing time estimate for the first message based on information derived from the second message.

16. The non-transitory computer-readable medium of claim 15, wherein the computer-executable instructions further comprise computer executable instructions to cause the one or more processing units to:
perform the updating as a just-in-time update of the user processing time estimate of the first message after determining the first user is accessing the user device and prior to presenting the time estimate of the first message on the user device.

17. The non-transitory computer-readable medium of claim 15, wherein the computer-executable instructions further comprise computer executable instructions to cause the one or more processing units to:
update the user processing time estimate in a time period between receiving the second message and determining the first user is accessing the user device.

18. The non-transitory computer-readable medium of claim 14, wherein the computer-executable instructions further comprise computer executable instructions to cause the one or more processing units to:
receive an indication of at least partial completion of an action related to the first message, the at least partial completion of the action performed by an individual other than the first user; and
update both the value assessment and the user processing time estimate of the first message based on the at least partial completion of the action.

19. An apparatus, comprising:
a network communications interface;
a memory; and
one or more processing units, communicatively coupled to the memory and the network communications interface, wherein the memory stores instructions configured to cause the one or more processing units to:
receive, via the network device, a first message at a first device, the first message from a first sending entity sent to a first user;
parse the first message to identify key identifiers within the first message;
categorize the first message based on the key identifiers, wherein categorizing includes associating the first message with at least one first context, the first context stored in a memory and forming an association of multiple messages related to each other based, in part, on content or subject matter references of each message;
generate a value assessment for the first message, the value assessment based on a value assessment metric, wherein the value assessment metric is based on a plurality of context variables and indicates a predicted priority level or importance level with respect to the first user acting in response to the first message;
determine the first user is accessing a user device; and
present said value assessment associated with a presentation of the first message on the user device.

20. The apparatus of claim 19, wherein the memory further stores instructions configured to cause the one or more processing units to:
generate a user processing time estimate to predict a time duration for the first user completing an act in response to the first message;
present the user processing time estimate of the first message with the presentation of the first message on the user device;
receive an indication of at least partial completion of an action related to the first message, the at least partial completion of the action performed by an individual other than the first user; and
update both the value assessment and the user processing time estimate of the first message based on the at least partial completion of the action.
